(19) United States
(12) Patent Application Publication
(10) Pub. No.: US 2014/0156387 A1
(43) Pub. Date: Jun. 5, 2014

(54) Generating Advertising Metrics Using Location Information

(71) Applicant: Facebook, Inc., Menlo Park, CA (US)

(72) Inventors: Sean Michael Bruich, Palo Alto, CA (US); Frederick Ross Leach, San Francisco, CA (US)

(73) Assignee: Facebook, Inc., Menlo Park, CA (US)

(21) Appl. No.: 13/693,470

(22) Filed: Dec. 4, 2012

(51) Int. Cl. G06Q 30/02

(52) U.S. Cl. CPC G06Q 30/0246
USPC 705/14.45

(57) ABSTRACT

A social networking system generates advertising metrics based on location information. Advertisers provide the social networking system with location information identifying geographic locations of physical sites and/or offline advertisements. Location information received by the social networking system for its users is compared to the location information provided by the advertiser to identify users visiting a physical site or exposed to an offline advertisement. Hence, user visitations to physical sites may be identified and analyzed in order to generate conversion metrics. User exposures to offline advertisements may also be identified and analyzed in order to generate exposure metrics.

### BACKGROUND

This invention generally relates to advertising metrics, and more specifically to generating advertising metrics using location information.

Advertisers expend significant resources on advertisements promoting their products, services, or brands. Often, advertisers communicate advertisements to potential customers using various forms of media including television, newspapers, radio, cinema, billboards, the Internet, and/or the like. Advertisers are typically interested in metrics measuring the effectiveness of such advertisements. For another example, advertisers are frequently interested in metrics measuring the effectiveness of advertisements in driving user visitation to physical sites, such as various retail stores. As another example, advertisers are often interested in metrics measuring the effectiveness of specific types of offline advertisements, such as billboards or posters.

To generate metrics describing advertisement effectiveness, advertisers often poll potential customers to determine whether the potential customers have been exposed to particular advertisements and/or whether exposure to particular advertisements caused the potential customers to visit certain physical sites of the advertisers. However, polling potential customers often results in receipt of unreliable answers because such potential customers may have limited recall regarding how they became aware of an advertiser's products or how they were enticed to visit the advertiser's physical sites. Such unreliable answers often cause advertising metrics generated using the answers to be inaccurate and/or skewed.

### SUMMARY

Embodiments of the invention are directed to generating advertising metrics using location information. As used herein, “location information” may be any data suitable for determining geographic locations of one or more users, advertisements, physical sites associated with advertisers, and/or any other suitable entities.

In one embodiment, a social networking system automatically generates conversion metrics for advertisements of an advertiser based on location information for social networking system users and location information for physical sites of the advertiser. The generated conversion metrics may measure effectiveness of the advertisements in inciting user visitation of the physical sites. As used herein, a “physical site” may be any physical location associated with an advertiser, such as a retail store, a company headquarters, or any physical location where brands, products or services of the advertiser may be promoted or sold.

In one implementation, to generate the conversion metrics, the social networking system assigns users to either a sample group or a holdout group (control group) for the advertisements. Users in the sample group are presented with one or more of the advertisements, while the advertisements are withheld from presentation to users in the holdout group. The social networking system also receives and stores location information identifying one or more physical sites associated with the advertiser. Subsequently, the social networking system obtains location information for users of the social networking system. The location information for the users may be obtained through any suitable method, such as receiving explicit user “check-ins” to particular geographic locations, receiving automatic communications from the client devices of the users, and/or through analyzing various social signals related to the users.

After obtaining the location information for the physical sites and users, the social networking system compares or matches the location information for the users and the location information for the physical sites to identify users that have visited one or more of the physical sites. Users visiting a physical site associated with the advertiser and included in the holdout group are identified. Similarly, users visiting a physical site associated with the advertiser and in the sample group are identified.

In one implementation, conversion metrics are then generated comparing (1) the number or percentage of users in the sample group that visited a physical site associated with the advertiser and (2) the number or percentage of users in the holdout group that visited a physical site associated with the advertiser. The resulting conversion metrics enable the advertiser to evaluate the effectiveness of the advertisements in driving users to visit physical sites associated with the advertiser (i.e., driving “foot traffic” to the physical sites associated with the advertiser). Other types of metrics relating to user conversion may also be generated.

In another embodiment, the social networking system may additionally or alternatively generate metrics describing user exposure to one or more offline advertisements using location information (“exposure metrics”). The exposure metrics include one or more metrics relating to the presentation of the one or more offline advertisements to social networking system users. As used herein, an “offline advertisement” refers to any advertisement that is not presented in an online context (e.g., presented over the Internet). Examples of offline advertisements include billboards, posters, advertisements on buildings, bench advertisements, vehicle wraparound advertisements, etc. Offline advertisements may be static or include multimedia content, such as text, audio, video, images, interactive content, etc. Hence, an offline advertisement may be electronic or non-electronic.

To generate the exposure metrics, the social networking system receives location information identifying geographic locations of one or more offline advertisements associated with an advertiser. The social networking system also obtains location information specifying geographic locations of users of the social networking system. User location information for the users may be obtained through receiving explicit user “check-ins” at particular geographic locations, receiving automatic communications from the client devices of the users, and/or analyzing various social signals related to the users.

The location information of the offline advertisements and the location information for the users are compared or matched to identify users that were exposed to the offline advertisements. For example, a user having location information indicating a geographic location that is within a specified distance of a geographic location indicated by the location information of an offline advertisement may be considered to have been exposed to the offline advertisement.

The social networking system may also obtain additional information for users identified as having been exposed to an offline advertisement. Examples of the additional information include data obtained through polling, data regarding purchase transactions, data regarding user visitation of physical sites, data regarding online actions performed by users, or any other suitable data.

In one implementation, based on the identified users and the additional information for the users, the social networking system generates one or more metrics for the offline advertisements and/or for the various types of the offline advertisements. For example, the social networking system uses purchase transaction data for the users exposed to a billboard to generate a metric describing a number of users that purchased a particular product after being exposed to the billboard.

In one implementation, the subsequent presentation of other advertisements can be influenced based on identified offline advertisement exposures. For example, an online advertisement may not be presented to a user until it has been identified that the user has been exposed to a particular offline advertisement.

Generating advertising metrics from location information increases the accuracy of conversion and/or exposure metrics. More specifically, by leveraging location information to identify user visitations of physical sites and user exposure to offline advertisements, the social networking system collects more accurate input data than when using conventional polling techniques. As a result, more precise conversion and/or exposure metrics can be generated using the input data, which better enables advertisers to assess their advertisements. Furthermore, by allowing identified exposures to offline advertisements to influence subsequent presentation of other advertisements, embodiments enable advertisers and/or other entities to have improved control over the frequency of exposure to advertising.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high level block diagram illustrating a system environment suitable for operation of a social networking system, in accordance with an embodiment of the invention.

FIG. 2 is a block diagram of various components of a social networking system, in accordance with an embodiment of the invention.

FIG. 3 is a flow chart of a process for generating conversion metrics using location information, in accordance with an embodiment of the invention.

FIG. 4 is a flow chart of a process for generating exposure metrics using location information, in accordance with an embodiment of the invention.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the system. In use, users join the social networking system by registering for an account. Thereafter, the social networking system may reliably determine the user based on the user account.

In one embodiment, the social networking system stores information related to each user as part of a user profile. The user profile may store any suitable information about a user, such as the user's demographics, including gender, age, geographical region, stated interests or preferences, professional, personal, or educational affiliations, income, etc. The user profile may also be associated with historical information regarding the activities of the user internal to and/or external to the social networking system. For example, the user profile may be associated with information regarding a user visiting various fan pages, searching for fan pages, “liking” fan pages, becoming a fan of fan pages, sharing fan pages, “liking” advertisements, commenting on advertisements, sharing advertisements, joining groups, attending events, checking-in to locations, buying products, etc. Information in the user profile may be used to selectively target the user for various advertisements.

The user profile may also include and/or be associated with information indicating connections between the user and additional users of the social networking system (e.g., friends, family members). For example, a first user accepts requests from other users of the social networking system to become connections of the first user. After the first user accepts the requests, the social networking system may store information indicating the users to which the first user is connected.

The user profile may also include location information indicating a current location and/or recent locations of a user. Such information may be received directly from the user (via check-ins), received automatically from the client devices of the user and/or derived from various social signals within the social networking system. As used herein, a “social signal” is any information about a user derived through analysis of the user's social network connections, actions internal to and/or external to the social networking system, and/or information stored in and/or associated with the user profile of the user. The preceding are merely examples of information that may be stored in, or associated with, a user profile, and any suitable information may be identified by the user profile.

The social networking system may generate advertising metrics for advertisements using location information associated with its users. In one embodiment, generated advertising metrics measure the effectiveness of one or more advertisements in encouraging users to visit physical sites (e.g., retail stores) associated with the advertiser. To generate the metrics, advertisements associated with the advertiser are presented to a sample group of social networking system users and withheld from presentation to a holdout group of social networking system users. After the advertisements are presented to the sample group, the social networking system compares location information for the users in the sample group and in the holdout group to location information associated with the advertiser's physical sites. Users having location information indicating geographic locations within a certain threshold distance of the geographic locations indicated by the location information of the physical sites are determined to have visited the physical sites. The identified user visitations and/or other data from users in the holdout group and in the sample group are then analyzed, compared, and/or contrasted to generate the conversion metrics.

Alternatively or additionally, the social networking system may use location information to generate exposure metrics for one or more offline advertisements. To generate the metrics, location information identifying geographic locations of offline advertisements are received and stored by the social networking system. The location information of the offline advertisements and location information associated with social networking system users are analyzed to identify users that have been exposed to the offline advertisements. Additional data for users exposed to the offline advertisements is obtained and analyzed. Examples of the additional data include purchase transaction data, polling data, or any other suitable data. Based on the additional data and the exposures to the offline advertisements, the social networking system generates exposure metrics for the offline advertisements. For example, the social networking system generates a metric indicating a number of users that purchased a particular product after viewing billboard type advertisements.

### System Architecture

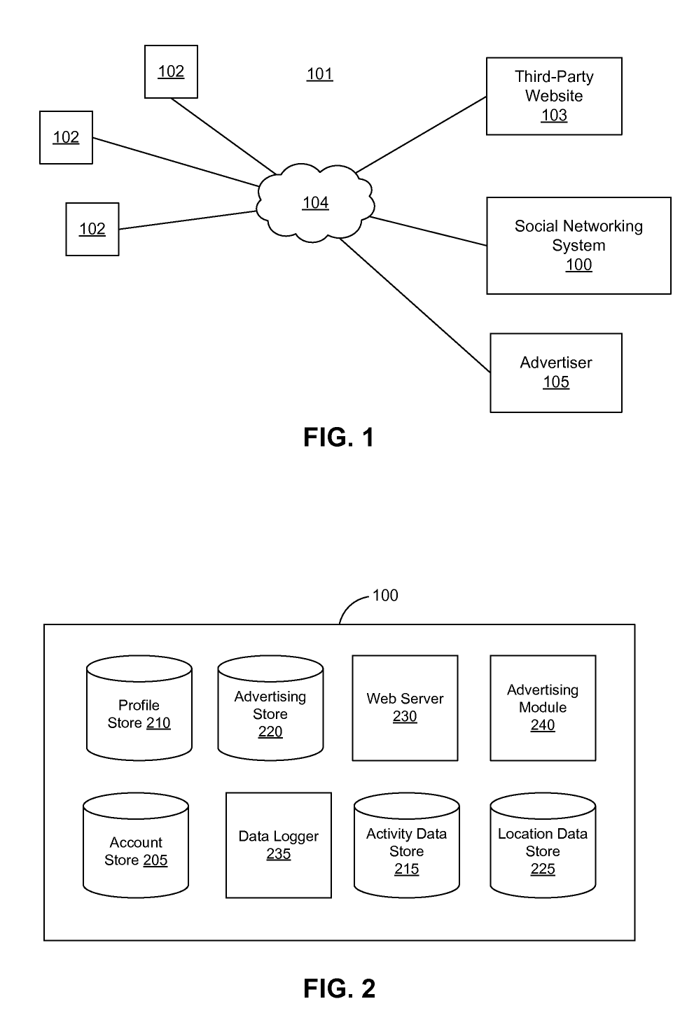

FIG. 1 is a high level block diagram illustrating one embodiment of a system environment 101 suitable for operation of a social networking system 100. As shown in FIG. 1, the system environment 101 includes one or more client devices 102, one or more third-party websites 103, a social networking system 100, and a network 104. While FIG. 1 shows three client devices 102, one third-party website 103, and one advertiser 105, it should be appreciated that any number of these entities (including millions) can be included. In alternative configurations, different entities can also be included in the system environment 101.

The client devices 102 are one or more computing devices that receive user input, as well as transmit and receive data via the network 104 to the social networking system 100. Hence, the client devices 102 enable users to access the functionalities of the social networking system 100. For example, interacting with a client device 102 allows a user to establish connections with other users via the social networking system 100. The client devices 102 also present content to users, including one or more advertisements. Additionally, a client device 102 may transmit location information to the social networking system 100, allowing the social networking system 100 to use the location information to determine a geographic location of a social networking system user associated with the client device 102.

Examples of client devices 102 include desktop computers, laptop computers, tablet computers (pads), mobile phones, personal digital assistants (PDAs), gaming devices, vehicles (e.g., automobiles, boats, airplanes), or any other device including computing functionality and data communication capabilities. As discussed, the client devices 102 are configured to communicate via the network 104, which may be any combination of local area and/or wide area networks using both wired and wireless communication systems. For example, the network 104 may be any combination of the Internet, a mobile network, a local area network (LAN), a wired or wireless network, a private network, a virtual private network and/or any other suitable communication mechanisms. The third-party website 103 is coupled to the network 104 to communicate with the social networking system 100 and/or with one or more client devices 102.

The advertiser 105 is an entity that provides advertisements to the social networking system 100 for presentation to social networking system users. Additionally, the advertiser 105 may provide advertisements to entities other than the social networking system 100. For example, the advertiser 105 may provide advertisements to various third-party websites 103 for presentation to the users of the third-party websites 103. The advertiser 105 may also present advertisements offline, such as on billboards, posters, television, radio, etc. The advertiser 105 may also be associated with one or more physical sites, such as retail stores, etc.

The advertiser 105 provides location information to the social networking system 100 identifying the geographic locations of physical sites and/or offline advertisements associated with the advertiser 105. The location information may include, for example, a set of GPS coordinates corresponding to geographic locations of the advertiser's physical sites. As another example, the location information may include a set of GPS coordinates corresponding to the geographic locations of the advertiser's offline advertisements.

The social networking system 100 is a computing system allowing its users to communicate or otherwise interact with each other and access content as described herein. In one embodiment, the social networking system 100 stores user accounts for one or more social networking system users. Associated with the user accounts, the social networking system 100 stores user profiles describing the social networking system users, including biographic, demographic, and other types of descriptive information, such as work experience, educational history, hobbies or preferences, location, and the like. Using information in the user profiles, connections between the user profiles, and actions associated with the user profiles, the social networking system 100 maintains a social graph describing connections between various users. Each connection may define a particular relationship between two users, such as a friendship relationship, a fan relationship, a follower relationship, etc. The social networking system 100 additionally stores other objects, such as fan pages, events, groups, advertisements, general postings, etc.

FIG. 2 is an example block diagram of one embodiment of the social networking system 100. In alternative configurations, different and/or additional components can be included in the system 100.

The account store 205 stores information for user accounts of various social networking system users. The information for a user account may include a user identifier, a username, a user password, user settings (e.g., user privacy settings), identifiers of client devices 102 associated with a user, or other similar information. Each user account is associated with a corresponding user profile. Data included in the account store 205 may be encrypted or otherwise secured to prevent unauthorized access to the data.

The profile store 210 stores user profiles associated with social networking system users. Each user profile may include demographic and other information associated with a particular user. Examples of information associated with a user include the user's gender, age, geographical location, education or professional affiliations, group memberships, interests, activities, income, nationality, race, and/or the like. For example, a stored user profile indicates that a particular user is 25 years old, lives in Cheyenne, works as a doctor, and enjoys horseback riding. In one embodiment, each user profile may also be associated with, or include, information about a user's connections (e.g., friends) in the social networking system 100 to other users of the social networking system 100. In one embodiment, data included in the profile store 210 may be encrypted or otherwise secured to prevent unauthorized access.

The activity data store 215 stores information describing one or more activities of users through the social networking system 100 and/or external to the social networking system 100. The information stored by the activity data store 215 describes any suitable online or offline activities. For example, the activity data store 215 includes data describing uses of a client device 102 by a user to login to or otherwise access the social networking system 100. Information stored in the activity data store 215 describes types for the stored activities. Example types include: expressing a preference for an object type (i.e., “liking” the object), expressing a desire for an object type (i.e., “wanting” the object), commenting on an object type, sharing an object type, searching for an object type, viewing an object type, posting content type, and generating content and/or advertisements type. The activity data store 215 further includes data describing actions performed with respect to the users, such as presentation of content to a user and/or exposure of one or more advertisements to the user. In one embodiment, the activity data store 215 may store data regarding purchases of products or services performed by social networking system users. The activity data store 215 may further store answers provided by users responsive to polling questions provided by the social networking system.

In one aspect, location information associated with users may be stored in the activity data store 215. For example, the activity data store 215 stores information indicating a geographic location at which a user has been or is currently located. The activity data store 215 may additionally store a time for which the user is located at the geographic location. For example, the activity data store 215 may store information indicating that a user is in the city of Los Angeles at 2:00 PM. Location information may be received in any suitable manner, including via explicit communication from users (e.g., a “check-in”), via communications from the client devices 102, or via any suitable action. To prevent unauthorized access, data in the activity data store 215 may be encrypted, or otherwise secured.

The advertising store 220 stores data describing one or more advertisements that may be presented to social networking system users. For example, the advertising store 220 stores an advertisement, data identifying an advertiser associated with the advertisement and other parameters associated with the advertisement. Additionally, targeting criteria may be stored and associated with the advertisement. Targeting criteria identifies one or more characteristics of a user eligible to be presented an associated advertisement. Targeting criteria may specify attributes from a user profile, such as user demographics (e.g., gender, age, geographical region, stated interests or preferences, professional, personal, or educational affiliations, income or other data included in a user profile). Different types of user affiliations may also be specified by targeting criteria, such as memberships in groups, lists, networks, forums, and clubs within the social networking system. For example, targeting criteria may specify that an advertisement be targeted towards members of a group of a shoe manufacturer's fans maintained by the social networking system 100.

Targeting criteria may also specify attributes of a user's actions performed inside and/or outside of the social networking system 100. Example targeting criteria based on user actions may specify frequency of use of the social networking system 100, length of time logged-in to the social networking system 100, access or use of specific features of the social networking system 100, etc. For example, an advertisement may be targeted to users who have used the social networking system 100 at least five times per week for the past month and who have used a gift giving application within the last three days. Hence, the targeting criteria may comprise any data maintained by the social networking system 100 or any suitable combination of data maintained by the social networking system 100.

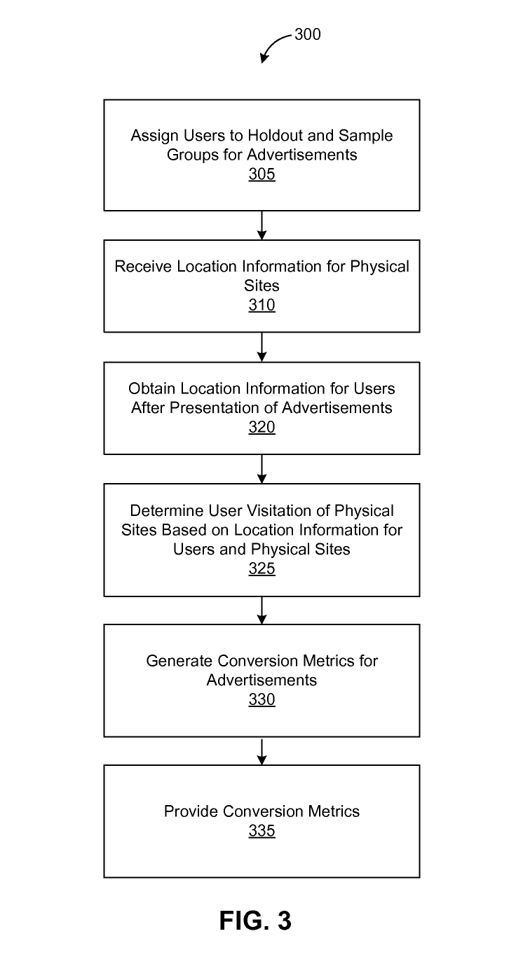

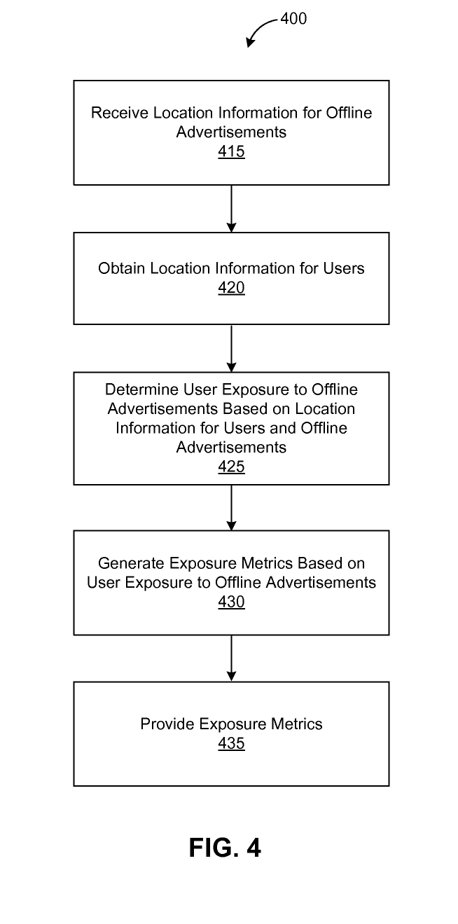

The location data store 225 stores positioning data for geographic locations of various places. For example, the location data store 225 includes coordinates specifying geographic locations of retail stores, buildings, landmarks, offline advertisements, or other suitable places. In one embodiment, the location data store 225 includes a set of entries, each including a place identifier (e.g., a landmark code, a store name, a street address, etc.) and a corresponding global positioning system (GPS) coordinate or other type of positioning data for the place. As further described below in conjunction with FIGS. 3 and 4, information from the location data store 225 and from the other stores may be used to determine user visitation of physical sites of an advertiser and/or user exposure to offline advertisements of an advertiser.

The web server 230 exchanges data between the social networking system 100, one or more of the client devices 102, and/or one or more third-party websites 103 via the network 104. For example, the web server 230 includes a mail server or other messaging functionality for receiving and routing messages between the social networking system 100 and the client devices 102 or third-party websites 103. The messages can be instant messages, queued messages (e.g., email), short message service (SMS) messages, multimedia messaging service (MMS) messages, or any other suitable type of message. In one embodiment, the web server 230 may receive a request for content to be displayed to a user of a client device 102, and the content is presented along with one or more advertisements.

The data logger 235 identifies and stores information regarding one or more activities performed internal to the social networking system 100 and/or external to the social networking system 100 in the activity data store 215. For example, the data logger 235 receives information describing a location of a social networking system user and logs the received location information in the activity data store 215. As another example, the data logger 235 receives information describing a purchase by a social networking system user via a third-party website 103 and stores a description of the purchase in the activity data store 215.

The advertising module 240 generates advertising metrics for one or more advertisements associated with an advertiser 105 based at least in part on location information. In one embodiment, the metrics include conversion metrics describing effectiveness of the advertisements in causing users to visit one or more physical sites associated with the advertiser 105. Additionally, exposure metrics describing user exposure to offline advertisements associated with the advertiser 105 may be generated. Combinations of the preceding metrics, as well as any other suitable metrics, may be generated by the advertising module 240. For example, metrics describing effectiveness of one or more offline advertisements in encouraging user visits to physical sites associated with the advertiser 105 may be generated. Generation of metrics is further described below in conjunction with FIGS. 3 and 4.

### Process for Generating Conversion Metrics Using Location Information

FIG. 3 illustrates one embodiment of a process 300 for generating conversion metrics from location information. Other embodiments may perform the steps of the process 300 in different orders and can include different, additional and/or fewer steps. The process 300 may be performed by any suitable entity, such as the advertising module 240.

In one embodiment, the advertising module 240 randomly or pseudo-randomly assigns 305 social networking system users to either a holdout group or a sample group for one or more advertisements associated with the advertiser 105. Users in the sample group are presented with one or more of the advertisements, while users in the holdout group are not presented with the one or more advertisements. Hence, when a request to present an advertisement to a user is retrieved and one of the advertisements is selected, a determination is made as to whether the user is in the holdout group. If the user is in the holdout group, the advertisement is not presented to the user, and an alternative advertisement is presented. If the user is not in the holdout group, the user is presented with the advertisement. Thus, the holdout group may serve as a control for the generation of metrics. Using holdout groups to generate advertising metrics is further described in U.S. patent application Ser. No. 13/658,480 filed on Oct. 23, 2012, titled “Determining Advertising Effectiveness Based on Observed Actions in a Social Networking System,” which is hereby incorporated by reference in its entirety.

The advertising module 240 additionally receives 310 location information for one or more physical sites associated with the advertiser 105. In one embodiment, the location information for the physical sites associated with the advertiser 105 is received 310 from the location data store 225. As discussed above, the physical sites may be any suitable places associated with the advertiser 105, such as retail stores, company headquarters, or any place where brands, products or services of the advertiser 105 may be promoted and/or sold. In one aspect, the received location information includes indicators for geographic locations for the physical sites. The received location information may also include various attributes of the geographic locations of the physical sites, such as nearby wireless access points, cell towers, etc.

To represent a geographic location, the location information for the physical sites may include any suitable types of data. Example types of such data include: place names, street data, global positioning system (GPS) data, data for various positioning systems (e.g., Galileo Data), longitude/latitude data, cell tower identifiers, wireless access point identifiers, or any other data. For example, the received location information may specify the city and street where a particular retail store of the advertiser 105 is situated. Alternatively, the location information may provide GPS coordinates for the geographic location of the particular retail store.

The one or more advertisements associated with the advertiser 105 are presented to social networking system users. As described above, when presenting an advertisement to a user, a determination is made as to whether the user is in the holdout group for the advertisements. If the user is not in the holdout group, the advertisement is presented to the user. If the user is in the holdout group, an alternative advertisement is presented to the user. In one implementation, the advertising module 240 presents the advertisements to the users. In another implementation, other entities (e.g., third-party websites 103) present the advertisements to the users.

The advertising module 240 obtains 320 location information for the social networking system users during a predefined time interval after presentation of the advertisements. In one aspect, the location information specifies current or recent geographic locations of the social networking system users. The location information may indicate geographic locations with street data, place names, GPS coordinates, etc. The location information may also indicate attributes of the users' current or recent geographic locations. Examples of attributes indicated by the location information include: cell tower identifiers, wireless access point identifiers, or other suitable data. Illustratively, the location information may identify a cell tower detected at a user's current geographic location.

In one embodiment, the advertising module 240 obtains location information via user-initiated communications. More specifically, a user may initiate a communication that explicitly indicates his or her current or recent geographic location. For instance, the advertising module 240 receives a “check-in” or other similar communication from a user identifying a current or recent location of the user. For example, the advertising module 240 may receive a “check-in” indicating that a user is at a retail store of the advertiser 105. As another example, the advertising module 240 receives a “check-in” from a user indicating the user is at a particular street address. Such a “check-ins” may be communicated to the users' friends or other social network connections over the social networking system 100.

Users' location information may also be obtained via communications from the client devices 102, such as location information automatically transmitted by a client device 102. Each communication may specify a current or recent geographic location of a client device 102, which provides an indication of a current or recent location of a user associated with the client device 102. For example, each communication includes a set of GPS coordinates describing the geographic location of a client device 102. In one aspect, location information automatically transmitted by a client device 102 may be subject to one or more user privacy settings. In particular, the advertising module 240 may not receive communications from a client device 102 if a user's privacy settings prohibit automatic transmission of location information to the social networking system 100 by the client device 102.

Social signals associated with social networking system users may also be used by the advertising module 240 to obtain 320 location information for users. For example, the advertising module 240 may analyze one or more of: the connections of a user to other users, the actions of the user, the content associated with the user, and/or any other suitable information. Based on the analysis, the advertising module 240 may derive location information for the user. For example, the advertising module 240 may obtain location information for a user from a geographic location associated with a digital photograph, post, or other content in which the user is tagged.

Based on the location information of physical sites associated with the advertiser 105 and the location information associated with the social networking system users, the advertising module 240 determines 325 one or more social networking system users that have visited at least one physical site associated with the advertiser 105. To determine 325 users that have visited a physical site associated with the advertiser 105, the advertising module 240 converts the location information for the social networking system users and/or the location information for the physical sites to a common format. For example, the location information obtained from the users may be street addresses and/or place names while the location information for the physical sites may be GPS coordinates. Hence, the advertising module 240 may convert the street addresses and/or place names to GPS coordinates. In one implementation, the advertising module 240 may access the location data store 225, or another suitable source, to identify GPS coordinates corresponding to street addresses and place names.

Users associated with location information indicating geographic locations within a threshold distance of a geographic location indicated by the location information of a physical site are determined 325 to have visited the physical site. For example, users having location information indicating a geographic location within 100 feet of a geographic location indicated by the location information of a physical site are determined 325 to have visited the physical site. The threshold distance may be specified by the advertiser 105 or by the social networking system 100 in various embodiments.

Alternatively, a user is determined 325 to have visited a physical site if attributes included in the location information associated with the user match at least a threshold number of attributes included in the location information of the physical site. For example, the location information for a particular physical site may identify a particular wireless access point with a particular service set identification (SSID) as being located at the geographic location of a physical site. If location information for a user indicates that a geographic location of the user includes a wireless access point with the same SSID, the user is determined 325 to have visited the physical site.

Based on the users determined to have visited a physical site associated with the advertiser 105 after presentation of the one or more advertisements, the advertising module 240 generates 330 one or more conversion metrics describing user visitations to physical sites after presentation of the advertisements.

In one embodiment, to generate the metrics, the advertising module 240 identifies users in the sample group that visited a physical site of the advertiser 105 from the determined users. The advertising module 240 additionally identifies users in the holdout group that visited a physical site of the advertiser 105 from the determined users. Thereafter, the number and/or percentage of users in the sample group visiting a physical site of the advertiser 105 and the number and/or percentage of users in the holdout group visiting a physical site of the advertiser 105 are analyzed, compared, and/or contrasted. In one implementation, differences between (1) the number and/or percentage of the users in the holdout group that visited a physical site and (2) the number and/or percentage of users in the sample group that visited a physical site are used to generate 330 metrics indicating the effect of the presented advertisements in facilitating or driving user visits to the physical sites associated with the advertiser 105.

For example, the advertising module 240 determines that, after presentation of the advertisements, 55% of the users in the sample group visited a store associated with an advertiser 105 while 45% of users in the holdout group visited a store of the advertiser 105. Hence, the advertising module 240 may generate a metric indicating that the advertisements increased user visits to stores by 10 percentage points.

In some embodiments, other suitable metrics for the one or more advertisements may also be generated based on user visitations determined based on location information. For example, the advertising module 240 may generate metrics indicating the total number of users that have visited each physical site of the advertiser 105. After generating the metrics, the advertising module 240 provides 335 the generated metrics to the advertiser 105 or some other suitable entity in any suitable format (e.g., tables, charts, etc.).

### Process for Generating Exposure Metrics Using Location Information

FIG. 4 illustrates one embodiment of a process 400 for generating exposure metrics using location information. Other embodiments may perform the steps of the process 400 in different orders and can include different, additional and/or fewer steps. The process 400 may be performed by any suitable entity, such as the advertising module 240.

In the embodiment, location information identifying geographic locations of offline advertisements associated with the advertiser 105 is received 415 by the advertising module 240. The received location information may include similar data as the location information for physical sites associated with the advertiser 105, further described above in conjunction with FIG. 3. Location information for offline advertisements may also include direction information specifying directions in which the advertisements are oriented. For example, location information for a particular offline advertisement may indicate that the advertisement faces north.

The advertising module 240 obtains 420 location information for social networking system users, as described above in conjunction with FIG. 3. For example, the advertising module 240 obtains 420 location information for social networking system users via user-initiated communications (e.g., check-ins), location information sent automatically by the client devices 102, and/or through analysis of various social signals. From the location information, the advertising module 240 determines the geographic locations of the social networking system users.

Based on the location information for the offline advertisements and the location information for the users of the social networking system, the advertising module 240 determines 425 social networking system users that have been exposed to the offline advertisements. For example, users associated with location information indicating geographic locations within a threshold distance of a geographic location indicated by location information associated with an offline advertisement are determined 425 to have been exposed to the offline advertisement. As another example, the advertising module 240 determines 425 social networking system users as having been exposed to an offline advertisement if the location information of the users includes a threshold number of geographic location attributes matching geographic location attributes of location information associated with the offline advertisement. Determinations that users have been exposed to offline advertisements based on location information can be performed similarly to determinations that users have visited physical sites based on location information, as described above in conjunction with FIG. 3.

In one embodiment, to identify users as having been exposed to an offline advertisement, the advertising module additionally considers the directions of the users. More specifically, the advertising module 240 determines directions of the users' movements based on the location information. In one embodiment, the advertising module 240 determines the direction a user moves based on changes in the geographic locations of the user over time. For example, over a 70 minute period, a user's location information may indicate that the user has progressively moved northward. This allows the advertising module 240 to determine that the user is facing north during the 70 minute period.

The advertising module 240 thereafter accounts for the direction in which an offline advertisement is oriented and a user's direction of motion when in proximity to the advertisement when determining 425 whether the user has been exposed to the offline advertisement. For example, if an offline advertisement is oriented north and the user is travelling north while within a threshold distance of the offline advertisement, the advertising module 240 determines 425 that the user was not exposed to the offline advertisement. However, if the user was travelling south while within the threshold distance of the offline advertisement, the advertising module 240 determines 425 that the user was exposed to the offline advertisement.

In one embodiment, to identify users as having been exposed to an offline advertisement, the advertising module additionally considers the velocities of the users. More specifically, the advertising module 240 determines velocities of the users' movements based on the location information. In one implementation, the advertising module 240 determines the velocity of a user's movements based on changes in the geographic locations of the user indicated by the location information over time. In particular, the advertising module 240 determines (1) a distance between different geographic locations of the user specified by the location information and (2) a time difference between the times the user was at each of the geographic locations. A speed or velocity of the user is determined based on the distance and the time difference.

Thereafter, the advertising module 240 determines whether a user has been exposed to an advertisement based on the velocity of the user when the user is within a threshold distance of an advertisement. For example, the user is not determined 425 to have been exposed to an offline advertisement if the user was travelling at greater than a threshold velocity while within a threshold distance of the offline advertisement. However, if the user's velocity does not exceed the threshold velocity, the advertising module 240 determines the user has been exposed to the offline advertisement. For example, a threshold speed may be 70 miles per hour. If the user is determined to have travelled at a speed of 25 miles per hour while within a threshold distance of an offline advertisement, the advertising module 240 determines 425 the user was exposed to the offline advertisement. Using velocity allows the advertising module 240 to more accurately determine 425 if a user was able to view an offline advertisement.

Based on the users determined to have been exposed to the offline advertisements of the advertiser 105, the advertising module 240 generates 430 one or more exposure metrics. To generate the exposure metrics, the advertising module 240 obtains additional data associated with the users exposed to the offline advertisements. In one embodiment, the obtained additional data includes data received via answers to polls provided to users having been exposed to the offline advertisements. The polls may include questions asking the users for their favorability towards the offline advertisements; favorability towards a brand, product, or service associated with the advertisements; or other information related to the advertisements.

The obtained additional data may also or alternatively include data describing activities of the users internal to the social networking system 100 and/or external to the social networking system 100. For example, descriptions of activities associated with content associated with the offline advertisements are retrieved from the activity data store 215. Examples of activities include: posting user generated content, expressing a preference for content, commenting on content, searching for content, establishing connections, joining groups, etc.

The obtained additional data may also or alternatively include purchase transaction data regarding users' purchases for products (virtual or non-virtual) or services associated with the advertisements. For example, the purchase transaction data may include information describing a user's purchases of products promoted by the advertisements. In one embodiment, the purchase transaction data is provided subject to user-specified privacy settings in the social network user profiles of the users, allowing users to regulate accessibility to their purchaser transaction data. The obtained additional data may also or alternatively include visitation data identifying physical sites visited by the user, such as retail stores associated with the advertiser 105.

Based on the obtained additional data for users exposed to the offline advertisements, the advertising module 240 generates 430 one or more advertising metrics for the offline advertisements. In one embodiment, the advertising module 240 generates 430 metrics for each offline advertisement. Alternatively, the advertising module 240 generates 430 metrics for different types of offline advertisements. Example types of offline advertisements include: media types (e.g., text based advertisements, image based advertisements, audio based advertisements, etc.), location types (e.g., advertisements situated on freeways, advertisement situated in residential neighborhoods, etc.), and format types (e.g., billboards, bench advertisements, posters, vehicle wraparounds, etc.). For example, the advertising module 240 generates 430 exposure metrics for billboard type advertisements and bench type advertisements of the advertiser 105. As another example, the advertising module 240 generates 430 exposure metrics for advertisements situated on freeways and advertisements situated in malls.

In one embodiment, the metrics generated for each offline advertisement or each type of offline advertisement includes metrics indicating a number of users that were exposed to the advertisement or type of offline advertisement. For example, a metric may indicate that 500 users were exposed to an advertiser's billboards situated on a freeway. In one embodiment, the metrics generated for each offline advertisement or each type of offline advertisement additionally or alternatively includes metrics related to user purchases, user visitation, brand favorability, etc. Such metrics may be based on the additional data obtained for the users.

In one embodiment, metrics describing user purchases associated with a particular offline advertisement (or particular type of offline advertisement) include a number of users that purchased products or services of the advertiser 105 after exposure to the offline advertisement (or the type of offline advertisement), a percentage of users that purchased products or services of the advertiser 105 after exposure to the offline advertisement (or the type of offline advertisement), average purchase amounts for products or services of the advertiser 105 after exposure to the offline advertisement (or the type of offline advertisement), or any other suitable metric. Such metrics may be based on the purchase transaction data obtained for the users.

Metrics describing user visitation associated with a particular offline advertisement (or particular type of offline advertisement) may include a number of users that visited a physical site of the advertiser 105 after exposure to the offline advertisement (or the type of offline advertisement), a percentage of users that visited a physical site of the advertiser 105 after exposure to the offline advertisement (or the type of offline advertisement), or any other suitable metric. Such metrics may be based on the user visitation data obtained for the users. Metrics describing favorability associated with a particular offline advertisement (or particular type of offline advertisement) may include a favorability or approval score for a brand, product, or service after exposure to the offline advertisement (or type of offline advertisement), or any other suitable metric. Such metrics may be based on user activity data and/or polling data for the users.

The advertising module 240 provides 435 the generated metrics to the advertiser 105 or to any other suitable entity. The generated metrics may be presented according to individual offline advertisements and/or to specific offline advertisement types. For example, the advertising module 240 may provide metrics indicating the percentages of users that purchased a product of the advertiser 105 with respect to advertisements located at freeways, advertisements located at bus stops, advertisements located on buildings, etc.

In one embodiment, subsequent presentation of offline and/or online advertisements to a social networking system user is influenced based on whether the user was determined to have been exposed to certain offline advertisements of an advertiser 105. For example, the advertising module 240 may receive a particular advertising sequence from the advertiser 105 specifying that certain advertisements are not presented to a user until the user is determined to have been exposed to a particular offline advertisement. Thus, the advertising module 240 does not present certain online advertisements, or other offline advertisements, until determining that the user has been exposed to the particular offline advertisement based on the user's location information. Illustratively, a video trailer for a new movie may not be presented to a user over the social networking system 100 until the user has been identified as having been exposed to a billboard promoting the movie. In this way, advertisers and/or other entities can have improved control over the frequency of exposure to advertising.

It will be appreciated that the embodiments described herein may be combined in any suitable manner to generate advertisement metrics. For example, the social networking system 100 generates metrics relating to the effectiveness of offline advertisements in inciting user visits to an advertiser's physical sites. Based on location information for users and location information of the physical sites, the social networking system 100 determines user visits to the physical sites. Further, based on location information for the users and location information of offline advertisements, the social networking system 100 determines users exposed to offline advertisements. Using the users exposed to the offline advertisements and their visits to physical sites, the social networking system 100 generates one or more metrics.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
selecting, from a plurality of users of a social networking system, a holdout group of users associated with an advertisement of an advertiser, wherein users from the plurality not in the holdout group are presented with the advertisement and users from the plurality in the holdout group are not presented with the advertisement;
receiving location information of one or more physical sites associated with the advertiser;
obtaining location information of one or more users from the plurality of users for a time interval after presentation of the advertisement;
identifying users that visited at least one of the physical sites based on the location information of the physical sites and the location information of the one or more users;
identifying users in the holdout group that visited at least one of the physical sites from the identified users that visited at least one of the physical sites;
identifying users not in the holdout group that visited at least one of the physical sites from the identified users that visited at least one of the physical sites; and
generating a conversion metric based at least in part on information associated with users in the holdout group that visited at least one of the physical sites and information associated with users not in the holdout group that visited at least one of the physical sites.

2. The computer-implemented method of claim 1, wherein obtaining the location information of the one or more users from the plurality of users comprises:
receiving a communication initiated by a user indicating a geographic location of the user.

3. The computer-implemented method of claim 2, wherein the geographic location of the user indicated by the received communication is provided to at least one other user connected to the user via the social networking system.

4. The computer-implemented method of claim 1, wherein obtaining the location information of the one or more users from the plurality of users comprises:
receiving a communication automatically transmitted from a client device associated with a user, the communication specifying a geographic location of the client device.

5. The computer-implemented method of claim 1, wherein obtaining the location information of the one or more users from the plurality of users comprises:
determining a geographic location for a user based on content associated with additional users connected to the user via the social networking system.

6. The computer-implemented method of claim 1, wherein identifying users that visited at least one of the physical sites comprises:
identifying a user associated with location information indicating a geographic location that is within a threshold distance of a geographic location indicated by location information associated with a physical site.

7. The computer-implemented method of claim 1, wherein at least one of the one or more physical sites comprises a physical location for purchasing a product or service associated with the advertiser.

8. The computer-implemented method of claim 1, wherein generating the conversion metric comprises:
determining a percentage of users in the holdout group that visited at least one of the physical sites;
determining a percentage of users not in the holdout group that visited at least one of the physical sites; and
determining a difference between the percentage of users in the holdout group that visited at least one of the physical sites and the percentage of users not in the holdout group that visited at least one of the physical sites.

9. The computer-implemented method of claim 1, wherein generating the conversion metric comprises:
determining a number of users in the holdout group that visited at least one of the physical sites;
determining a number of users not in the holdout group that visited at least one of the physical sites; and
determining a difference between the number of users in the holdout group that visited at least one of the physical sites and the number of users not in the holdout group that visited at least one of the physical sites.

10. A computer-implemented method comprising:
receiving information regarding presentation of an advertisement to a subset of a plurality of users of a social networking system;
determining a geographic location for a physical site associated with the advertisement;
identifying one or more user visitations to the physical site after presentation of the advertisement based at least in part on a determination that one or more of the plurality of users have been in proximity to the physical site, wherein determination that one or more of the plurality of users have been in proximity to the physical site is based at least in part on the determined geographic location for the physical site; and
generating a metric describing user conversion after presentation of the advertisement based at least in part on the identified one or more user visitations to the physical site and the received information regarding presentation of the advertisement to the subset of the plurality of users of the social networking system.

11. The computer-implemented method of claim 10, wherein generating the metric comprises:
determining a percentage of users that were presented with the advertisement that visited the physical site based on the identified user visitations and the received information regarding presentation of the advertisement;
determining a percentage of users that were not presented with the advertisement that visited the physical site based on the identified user visitations and the received information regarding presentation of the advertisement; and
determining a difference between (1) the percentage of users that were presented with the advertisement that visited the physical site, and (2) the percentage of users that were not presented with the advertisement that visited the physical site.

12. The computer-implemented method of claim 10, wherein generating the metric comprises:
determining a number of conversions for users presented with the advertisement based on the identified user visitations and the received information regarding presentation of the advertisement;
determining a number of conversions for users that were not presented with the advertisement based on the identified user visitations and the received information regarding presentation of the advertisement; and
determining a difference between (1) the number of conversions for users presented with the advertisement, and (2) the number of conversions for users that were not presented with the advertisement.

13. A computer-implemented method comprising:
obtaining location information for one or more offline advertisements associated with an advertiser, the location information specifying one or more geographic locations for the one or more offline advertisements;
obtaining location information for one or more users of a social networking system, the location information specifying one or more geographic locations for the one or more users of the social networking system;
identifying users exposed to at least one of the one or more offline advertisements based at least in part on the location information for the one or more offline advertisements and the location information for the one or more users of the social networking system; and
generating one or more exposure metrics describing at least one characteristic of users identified as having been exposed to at least one of the offline advertisements.

14. The computer-implemented method of claim 13, wherein the location information for the one or more offline advertisements specifies a direction of a particular offline advertisement of the one or more offline advertisements, and wherein identifying users exposed to at least one of the offline advertisements comprises:
identifying a direction of movement for a user based on a change in geographic location of the user over a time interval indicated by location information associated with the user; and
determining whether the user was exposed to the particular offline advertisement based at least in part on the direction of movement for the user and the direction of the particular offline advertisement.

15. The computer-implemented method of claim 13, wherein identifying users exposed to at least one of the offline advertisements comprises:
determining a velocity of a user within a threshold distance of an offline advertisement based on a change in geographic location of the user over a time interval indicated by location information associated with the user; and
identifying the user as having been exposed to the offline advertisement if the velocity of the user does not exceed a threshold velocity.

16. The computer-implemented method of claim 13, wherein obtaining location information for the one or more users comprises:
receiving a communication generated by a user indicating a geographic location associated with the user.

17. The computer-implemented method of claim 13, wherein obtaining location information for the one or more users comprises:
determining a geographic location for a user based on content associated with additional users connected to the user via the social networking system.

18. The computer-implemented method of claim 13, wherein generating the one or more exposure metrics comprises:
retrieving purchase transaction data for one or more users identified as having been exposed to at least one of the offline advertisements, the purchase transaction data indicating one or more purchases by the one or more users identified as having been exposed to at least one of the offline advertisements and the purchase transaction data being associated with the advertiser; and
generating one or more metrics based on the retrieved purchase transaction data.

19. The computer-implemented method of claim 13, wherein generating the one or more exposure metrics comprises:
retrieving activities by one or more users identified as having been exposed to at least one of the offline advertisements, wherein one or more of the activities are associated with the advertiser; and
generating one or more exposure metrics based on the retrieved activities.

20. The computer-implemented method of claim 13, wherein generating the one or more exposure metrics comprises:
providing one or more polls to one or more users identified as having been exposed to at least one of the offline advertisements, wherein the one or more polls are associated with the advertiser; and
generating one or more exposure metrics based on data received in response to the provided one or more polls.
